(19) United States
(12) Patent Application Publication
(10) Pub. No.: US 2011/0044478 A1
(43) Pub. Date: Feb. 24, 2011

(54) PORTABLE ELECTRONIC DEVICE AND AUDIO OUTPUT AND INPUT CONTROLLING METHOD THEREOF

(75) Inventor: KAI-BO QU, Shenzhen (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/616,308

(22) Filed: Nov. 11, 2009

(30) Foreign Application Priority Data
Aug. 19, 2009 (CN) 200910305771.0

(51) Int. Cl. H02B 1/00

(52) U.S. Cl. 381/123

(57) ABSTRACT

A portable electronic device includes a housing including a first end and a second end opposite to the first end, a speaker unit including a first speaker near the first end of the housing and a second speaker near the second end of the housing, a microphone unit including a first microphone near the second end of the housing and a second microphone near the first end of the housing, and a controlling module set in the housing. The controlling module senses the orientations of the portable electronic device, and then controls corresponding speaker and microphone combination to output and input audio signals respectively.

### BACKGROUND

1. Technical Field

The disclosure generally relates to portable electronic devices, particularly to a portable electronic device having a plurality of speakers and microphones, and an audio output and input controlling method thereof.

2. Description of Related Art

With development of wireless communication and information processing technologies, portable electronic devices such as mobile telephones and personal digital assistants (PDAs), are now widely used. Most of these portable electronic devices include a speaker and a microphone separately arranged at opposite ends thereof. However, to obtain acceptable communication quality, users usually must hold the portable electronic devices in a certain direction/orientation that the speaker and the microphone are respectively located near the ear and mouth of the user.

Therefore, there is room for improvement within the art.

### BRIEF DESCRIPTION OF THE DRAWINGS

Many aspects of the portable electronic device and audio output and input controlling method thereof can be better understood with reference to the following drawings. The components in the drawings are not necessarily drawn to scale, the emphasis instead being placed upon clearly illustrating the principles of the portable electronic device and audio output and input controlling method thereof.

FIG. 1 shows a schematic view of a portable electronic device, according to an exemplary embodiment.

FIG. 2 shows a block diagram of a speaker unit, a microphone unit, a display, and a controlling module of the portable electronic device shown in FIG. 1.

FIG. 3 shows a flow chart of an audio output and input controlling process of the portable electronic device shown in FIG. 1.

### DETAILED DESCRIPTION

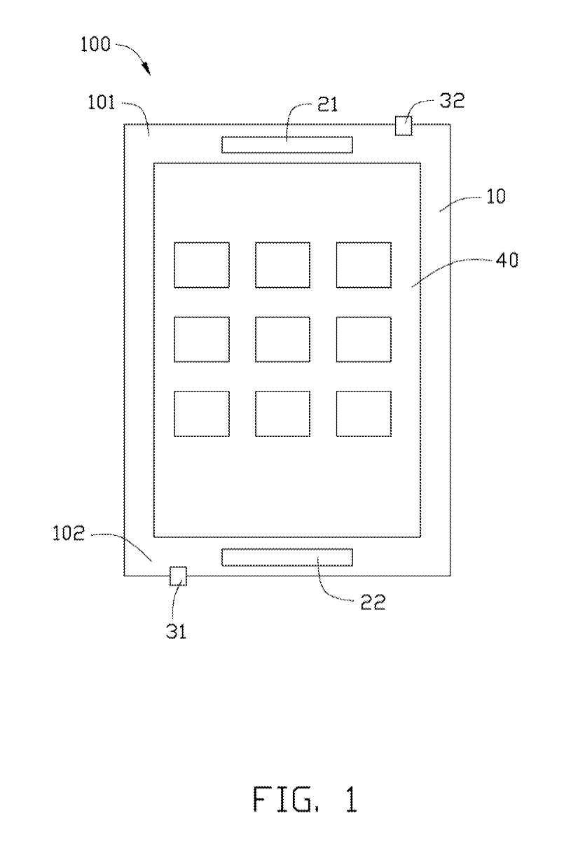

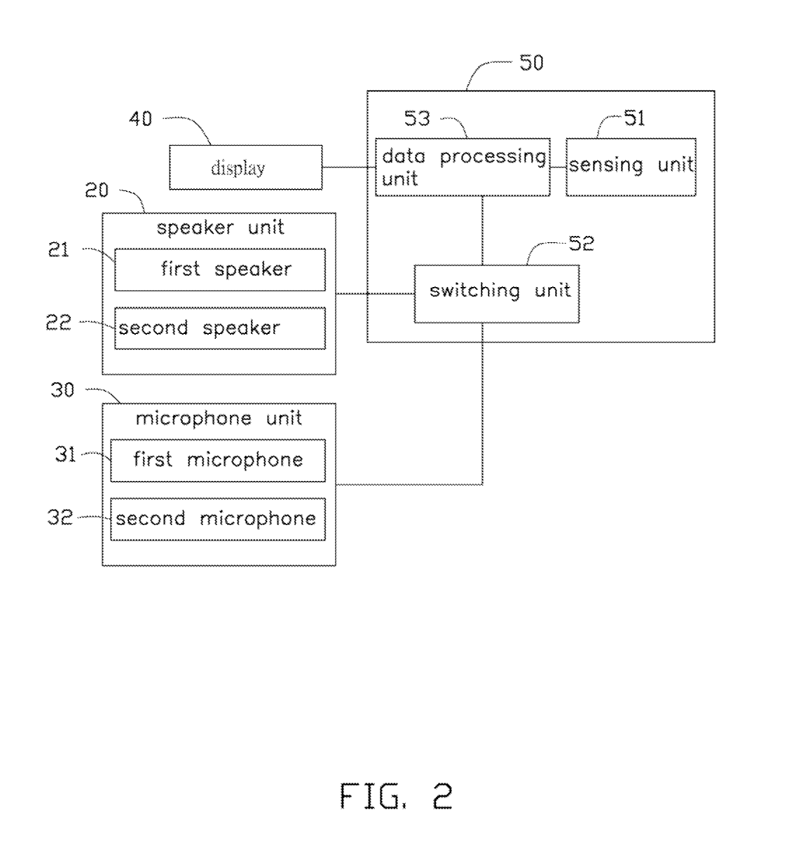

Referring to FIGS. 1-2, an exemplary embodiment of a portable electronic device 100, such as a mobile phone, a personal digital assistant (PDA) includes a housing 10, a speaker unit 20, a microphone unit 30, a display 40, a controlling module 50.

The housing 10 includes a first end 101 and an opposite second end 102. The speaker unit 20 includes a first speaker 21 and a second speaker 22. The first speaker 21 is near the first end 101 of the housing 10. The second speaker 22 is near the second end 102 of housing 10. The microphone unit 30 includes a first microphone 31 and a second microphone 32. The first microphone 31 is near the second end of the housing 10 with the second speaker 22. The second microphone 32 is near the first end of the housing with the first speaker 21.

The display 40 is disposed in the middle of one surface of the housing 10. The display 40 has a plurality of display modes. In this embodiment, the display 40 has three display modes corresponding to different orientations of the portable electronic device 100. When the portable electronic device 100 is orientated in a first direction where the first speaker 21 is above the second speaker 22, the display 40 displays information in a first display mode. When the portable electronic device 100 is orientated in a second direction where the first speaker 21 is below the second speaker 22, the display 40 displays information in a second display mode. When the portable electronic device 100 is orientated in a third direction where the first speaker 21 and the second speaker 22 are substantially at the same height, the display 40 displays information in a third display mode.

The controlling module 50 is disposed in the housing 10 of the portable electronic device 100. The controlling module 50 judges the orientation of the portable electronic device 100, and then controls the corresponding speaker and microphone to output and input audio signals and the display 40 to display in a corresponding display mode. The controlling module 50 includes a sensing unit 51, a switching unit 52, and a data processing unit 53. The sensing unit 51 and the switching unit 52 are electrically connected to the data processing unit 53.

The sensing unit 51 is an orientation detector and senses the orientation the portable electronic device 100. In this embodiment, the sensing unit 51 can sense at least three orientations of the portable electronic device 100 and generates three different direction signals corresponding to each orientation.

The switching unit 52 may be a relay. One end of the switching unit 52 is electrically connected to the data processing unit 53, and another end of the switching unit 52 is electrically connected to the speaker unit 20 and the microphone unit 30. The switching unit 52 has a plurality of modes to select different combinations of speakers in the speaker unit 20 and microphones in the microphone unit 30. In the first mode, the switching unit 52 selects the first speaker 21 and the first microphone 31 to connect to the data processing unit 53. In the second mode, the switching unit 52 selects the second speaker 22 and the second microphone 32 to connect to the data processing unit 53. In the third mode, the switching unit 52 selects the first speaker 21 and the second speaker 22 to connect to the data processing unit 53.

The data processing unit 53 may be a microprocessor of the portable electronic device. The data processing unit 53 receives the direction signals of the portable electronic device 100 from the sensing unit 51, and then controls the switching unit 52 to select the corresponding modes and controls the display 40 to display information in corresponding display modes. For example, when the data processing unit 53 receives a direction signal from the sensing unit 51 indicating that the portable electronic device 100 is orientated in the first direction, the data processing unit 53 controls the switching unit 52 to select the first speaker 21 and the first microphone 22 to output and input audio signals, and also controls the display 40 to display information in the first display mode.

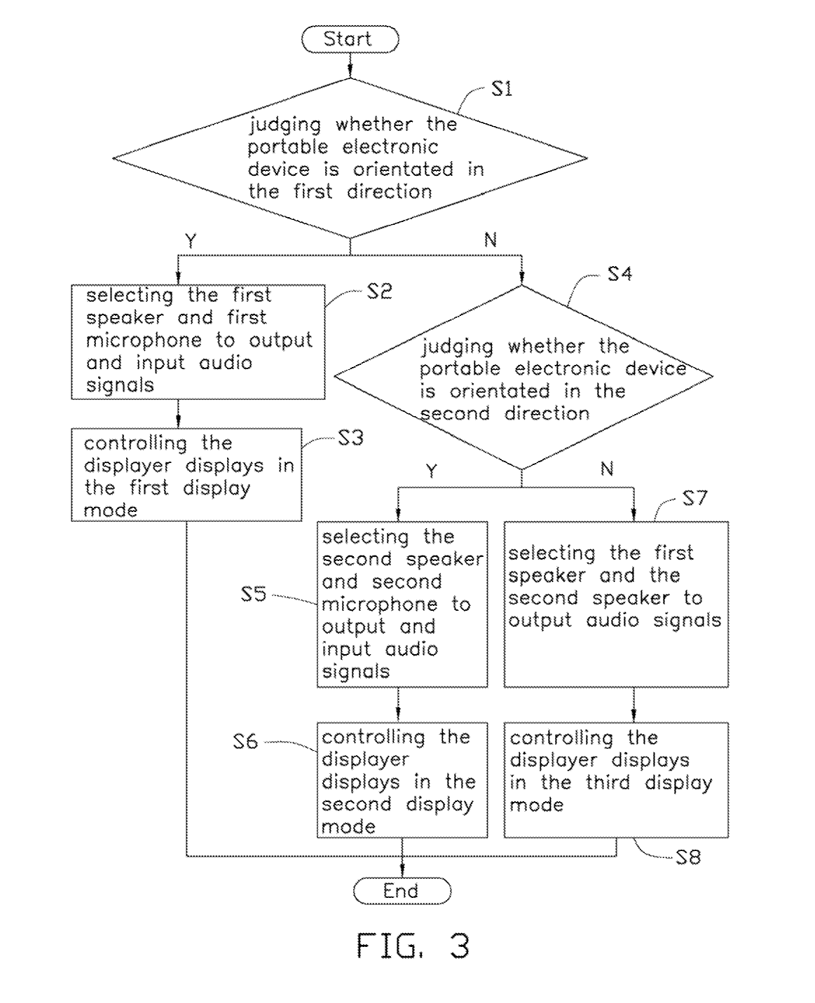

Referring to FIG. 3, the audio output and input controlling process of the portable electronic device 100 may include following steps:

In step S1, the data processing unit 53 judges whether the portable electronic device 100 is orientated in the first direction, if yes, the process goes to step S2; if no, the process goes to step S4.

In step S2, the data processing unit 53 controls the switching unit 52 to select the first speaker 21 and first microphone 31 to output and input audio signals, respectively and the process then goes to step S3.

In step S3, the data processing unit 53 controls the display 40 to display information in the first display mode.

In step S4, the data processing unit 53 judges whether the portable electronic device 100 is orientated in the second direction, if yes, the process goes to step S5; if no, the process goes to step S6.

In step S5, the data processing unit 53 controls the switch 52 to select the second speaker 22 and second microphone 32 to output and input audio signals, respectively and the process then goes to step S6.

In step S6, the data processing unit 53 controls the display 40 to display information in the second display mode.

In step S7, the data processing unit 53 controls the switch 52 to select the first speaker 21 and the second speaker 22 to output audio signals, respectively and the process then goes to step S8.

In step S8, the data processing unit 53 controls the display 40 to display information in the third display mode.

In another embodiment, the switching unit 52 may select the first speaker 21, the second speaker 22, the first microphone 31 and the second microphone 32 to connect to the data processing unit 53 in the third mode, and in the step S8, the data processing unit 53 controls the switching unit 52 to select the first speaker 21, the second speaker 22, the first microphone 31 and the second microphone 32 to output and input audio signals, respectively.

The portable electronic device 100 can freely and conveniently controls corresponding speaker and microphone to output and input audio signals according to different orientations, and not limited to a specific orientation. Furthermore, the portable electronic device 100 also has a different display mode for each orientation.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device, comprising:
a housing including a first end and an opposite second end;
a speaker unit including a first speaker near the first end of the housing and a second speaker near the second end of the housing;
a microphone unit including a first microphone near the second end of the housing and a second microphone near the first end of the housing; and
a controlling module set in the housing; wherein the controlling module senses the orientation of the portable electronic device, and then controls a corresponding speaker and microphone combination to output and input audio signals, respectively.

2. The portable electronic device as claimed in claim 1, wherein the controlling module includes a sensing unit, a switching unit, and a data processing unit; the sensing unit senses at least three orientations of the portable electronic device and generates a different direction signal corresponding to each of the at least three different orientations, and the data processing unit controls the switching unit to select a corresponding speaker and microphone combination to output and input audio signals, respectively, according to the direction signals.

3. The portable electronic device as claimed in claim 2, wherein when the first speaker is above the second speaker, the switching unit selects the first speaker and the first microphone to output and input audio signals, respectively.

4. The portable electronic device as claimed in claim 1, wherein when the first speaker is below the second speaker, the switching unit selects the second speaker and the second microphone to output and input audio signals, respectively.

5. The portable electronic device as claimed in claim 1, wherein when the first speaker and the second speaker are substantially at the same height, the switching unit selects the first speaker and the second speaker to output audio signals, respectively.

6. The portable electronic device as claimed in claim 1, wherein when the first speaker and the second speaker are substantially at the same height, the switching unit selects the first and second speakers and the first and second microphones to output and input audio signals, respectively.

7. The portable electronic device as claimed in claim 1, further comprising a display including a plurality of display modes, the controlling module also controlling the display to display information in different display modes corresponding to the different orientations of the portable electronic device.

8. An audio output and input controlling method of a portable electronic device, comprising:
providing a portable electronic device including a first speaker, a second speaker, a first microphone, a second microphone, and a display;
judging the orientation of the portable electronic device; and
selecting a corresponding speaker and microphone combination to output and input audio signals, respectively, according to each orientation.

9. The audio output and input controlling method as claimed in claim 8, wherein the portable electronic device includes three orientations.

10. The audio output and input controlling method as claimed in claim 9, further comprising selecting the first speaker and the first microphone to output and input audio signals, respectively, when the first speaker is above the second speaker.

11. The audio output and input controlling method as claimed in claim 9, further comprising selecting the second speaker and the second microphone to output and input audio signals, respectively, when the first speaker is below the second speaker.

12. The audio output and input controlling method as claimed in claim 9, further comprising selecting the first speaker and the second speaker to output audio signals when the first speaker and the second speaker are substantially at the same height.

13. The audio output and input controlling method as claimed in claim 9, further comprising selecting the first and second speaker and the first and second microphones to output and input audio signals, respectively, when the first speaker and the second speaker are substantially at the same height.

14. The audio output and input controlling method as claimed in claim 9, further comprising controlling the display to display information in different display modes according to each different orientation.
